(19) United States
(12) Patent Application Publication
(10) Pub. No.: US 2023/0088840 A1
(43) Pub. Date: Mar. 23, 2023

(54) DYNAMIC ASSESSMENT OF CRYPTOCURRENCY TRANSACTIONS AND TECHNOLOGY ADAPTATION METRICS

(71) Applicant: Bank of America Corporation, Charlotte, NC (US)

(72) Inventors: Ramakrishnamraju Rudraraju, Hyderabad (IN); Om Purushotham Akarapu, Hyderabad (IN)

(21) Appl. No.: 17/482,960

(22) Filed: Sep. 23, 2021

(51) Int. Cl. G06Q 20/40; G06Q 40/02; G06Q 20/10; G06Q 20/32; G06N 5/02

(52) U.S. Cl. CPC G06Q 20/4016; G06Q 40/02; G06Q 20/405; G06Q 20/1085; G06Q 20/3223; G06N 5/022; G06Q 20/367

(57) ABSTRACT

Aspects of this disclosure relate to use of a monitoring platform for detection of money mule accounts. The monitoring platform may monitor financial and non-financial transactions and/or other activities associated with an account to generate various statistical and technology adaptation metrics. The statistical and technology adaptation metrics may be used by a rules engine to determine whether the account is a potential money mule.

### TECHNICAL FIELD

Aspects described herein generally relate to artificial intelligence (AI)-based detection of fraudulent financial activity, and more specifically to detection of fraudulent financial activities based on assessment of cryptocurrency transactions.

### BACKGROUND

A money mule is someone who transmits money on behalf of someone else, often in an effort to clean or “launder” the money. Malicious actors typically use money mules to transfer illegally-obtained money (e.g., proceeds of money laundering, online fraud, or other scams) between different accounts. For example, a money mule may be asked to accepts funds at a source account associated with the money mule and initiate an electronic wire transfer to a destination account (often a foreign account). The destination account may be associated with the malicious actor themselves, or with another money mule. This chain of transactions between different accounts enables obscuring of a source of funds and further enables the malicious actors to distance themselves from fraudulent activity. Detection of such transfers remains a challenge for financial institutions.

Financial and regulatory institutions typically use various “risk scores” for predicting transactions and financial accounts that may be suspected to be involved in money laundering and other illegal activities. These scores are calculated based on client information (e.g., provided at the time of opening of an account). However, these methods often misclassify accounts as high-risk and fail to account for variations in usage of financial accounts by individual clients. Additionally, cryptocurrencies are being increasingly used to facilitate money laundering activities. Cryptocurrency can be bought and sold in return for traditional currency using an exchange. Since cryptocurrencies operate outside of traditional banking and financial networks, banking and regulatory agencies face difficulties in detecting suspicious activity, identifying users, and gathering transaction records. Risk scores by themselves are unable to account for potential usage of cryptocurrency by an account for illegal transactions.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of this disclosure provide effective, efficient, scalable, and convenient technical solutions that address various issues associated with electronic and automated detection of potential money mule accounts. One or more aspects relate to classification of cryptocurrency transactions and features associated with the cryptocurrency transactions using statistical and natural language processing (NLP) techniques. Additional aspects relate to determination of technology adaptation scores as a function of technology usage metrics by users. The features associated with the cryptocurrency transactions and/or the technology adaptation scores may be used to classify potential money mule accounts (e.g., using a machine learning-based rules engine).

In accordance with one or more arrangements, a monitoring platform may comprise at least one processor; and memory storing computer-readable instructions that, when executed by the at least one processor, cause the monitoring platform to perform one or more operations. The monitoring platform may receive, for a plurality of time periods, activity information associated with a user banking account corresponding to a user. The activity information may comprise a record of transactions associated with one or more banking platforms. The monitoring platform may determine, based on the activity information, one or more transactions, among the transactions, associated with cryptocurrency and further determine properties associated with the one or more transactions. The monitoring platform may calculate, based on the activity information, technology adaptation scores associated with the plurality of time periods. The technology adaptation score may be based at least on a frequency of usage of an online banking portal. The monitoring platform may determine, using a rules engine, based on the properties and the technology adaptation scores, whether the user banking account is a money mule account. The monitoring platform may, based on a determination that the user banking account is a money mule account, perform a remedial action. The remedial action may comprise, for example, sending, to a computing device, a notification indicating the user banking account.

In some arrangements, the rules engine may be associated with a plurality of rules. The plurality of rules may be determined at least based on historical activity information associated with a plurality of user banking accounts.

In some arrangements, each transaction in the record of transactions may be associated with a transaction description. The determining the one or more transactions may be based on performing natural language processing (NLP) on descriptions associated with the transactions.

In some arrangements, the properties may comprise one of: transaction values corresponding to the one or more transactions; transaction frequencies of transactions corresponding to one or more transaction types; a median transaction value corresponding to the one or more transactions; a mean transaction value corresponding to the one or more transactions; and combinations thereof.

In some arrangements, the one or more transaction types may comprise one of: a first transaction type indicating an outgoing fund transfer to a cryptocurrency account; a second transaction type indicating an incoming fund transfer from a cryptocurrency account; and combination thereof.

In some arrangements, the banking platforms may comprise one of: automatic teller machines (ATMs); computing devices at physical banking locations; the online banking portal accessible via a uniform resource locator (URL); call center platforms for phone banking; and combinations thereof.

In some arrangements, the transactions may comprise one of: checking an account balance of the user banking account; initiating an outgoing fund transfer from the user banking account; logging into the user banking account via the online banking portal; receiving an incoming fund transfer to the user banking account; using automatic teller machines (ATMs) to access the user banking account; and combinations thereof.

In some arrangements, the outgoing fund transfer may be a fund transfer to a cryptocurrency wallet, and the incoming fund transfer is a fund transfer from the cryptocurrency wallet.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for detection of money mule accounts, in accordance with one or more aspects described herein;

FIG. 1B shows an example monitoring platform, in accordance with one or more aspects described herein;

FIG. 2 shows an example method for detection of money mule accounts, in accordance with one or more aspects described herein;

FIG. 3 shows an example event sequence for detection of money mule accounts, in accordance with one or more aspects described herein and

FIG. 4 shows a simplified example of an artificial neural network on which a machine learning algorithm for money mule account detection may be executed, in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect. The examples and arrangements described are merely some example arrangements in which the systems described herein may be used. Various other arrangements employing aspects described herein may be used without departing from the invention.

Monitoring of fund transfers for detecting suspicious activity remains a challenging task for financial institutions. Suspicious activity may include use of money mules (often unwitting actors) for initiating transfers, in a chain of transfers involving multiple intermediary accounts, from a source account to a destination account. Such transactions are often used for illegal activities (e.g., money laundering, transferring funds obtained using online scams, etc.) while remaining anonymous to law enforcement agencies. Risk scores, calculated based on various factors, may be used to detect accounts that may be suspected to be involved in money mule transactions. For example, a risk score associated with an account may be calculated based on user physical location, internet protocol address (IP) addresses associated with online banking user activity, physical locations corresponding to user banking activities, account verification based on know your client (KYC) guidelines, etc.

However, cryptocurrency transactions may be difficult to account for in traditional risk scores. In an example money mule transaction using cryptocurrency, the malicious actor may initiate a currency transfer to the individual's (coerced to act as a money mule) bank account. The individual may then be asked to purchase cryptocurrency (e.g., via a cryptocurrency exchange using a debit/credit card) and transfer the cryptocurrency to a private key associated with another cryptocurrency wallet. Cryptocurrency-based transactions occur outside of traditional banking systems and are obfuscated to banking and regulatory authorities. For example, the private key is not tagged to any particular individual or organization, and may be associated with a user or organization located outside the country, anywhere in the world. The anonymity and decentralization facilitated by the use of cryptocurrencies may increase the difficulty for financial institutions to monitor transactions and flag suspicious mule accounts. A traditional risk score may not account for the use of cryptocurrency and may be unable to identify money mule accounts that use cryptocurrency for money transfer.

Various examples herein relate to usage of cryptocurrency transactions and technology adaptation associated with a user account to determine anomalous account activity associated with a user. Machine learning and natural language processing (NLP) algorithms may be used to determine cryptocurrency transactions. A monitoring platform may determine various metrics/properties associated with cryptocurrency transactions. These metrics may be combined with technology adaptation scores associated with the user account to determine (e.g., using a machine learning-based rules engine) whether it is a potential money mule account. The use of these parameters in addition to risk scores may enable more efficient and accurate detection of money mule accounts.

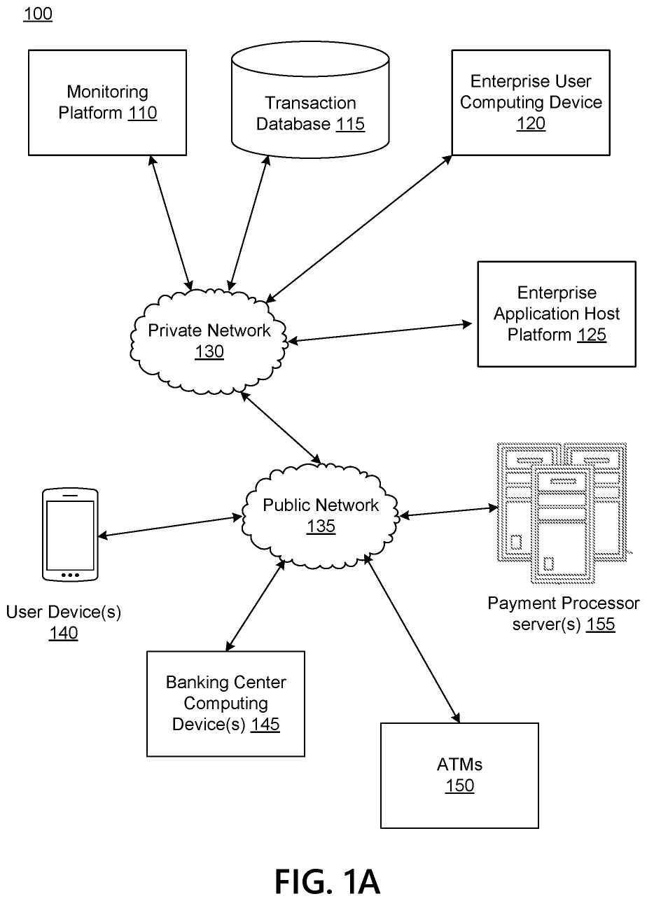

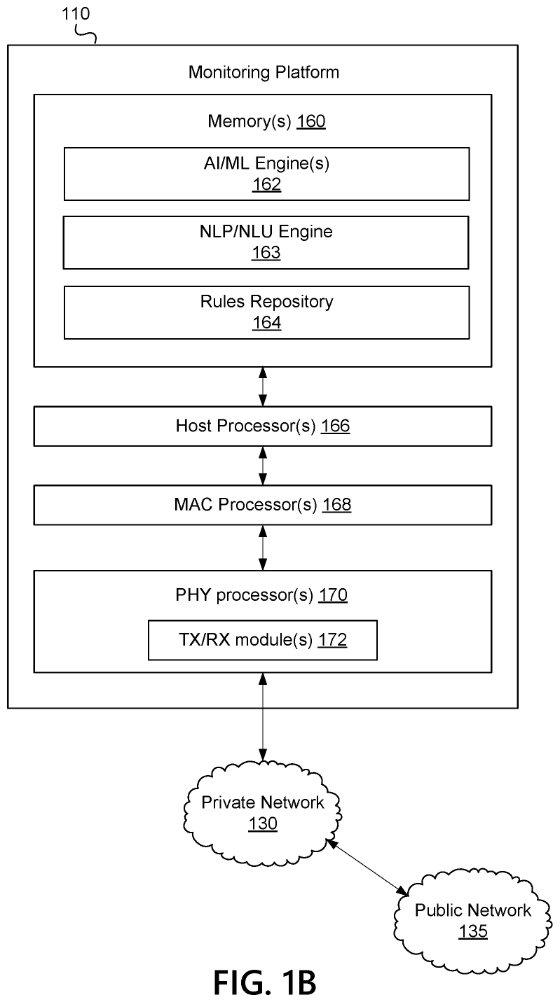

FIG. 1A shows an illustrative computing environment 100 for detection of money mule accounts, in accordance with one or more arrangements. The computing environment 100 may comprise one or more devices (e.g., computer systems, communication devices, and the like). The computing environment 100 may comprise, for example, a monitoring platform 110, a transaction database 115, an enterprise application host platform 125, an enterprise user computing device 120, etc. The one or more of the devices and/or systems, may be linked over a private network 820 associated with an enterprise organization (e.g., a financial institution). The computing environment 100 may additionally comprise user device(s) 140, banking center computing device(s) 145, automatic teller machines (ATMs) 150, payment processor server(s) 155 that are connected, via a public network 135, to the devices in the private network 130. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.).

The enterprise application host platform 125 may comprise one or more computing devices and/or other computer components (e.g., processors, memories, communication interfaces). In addition, the enterprise application host platform 125 may be configured to host, execute, and/or otherwise provide one or more enterprise applications. For example, the enterprise application host platform 125 may be configured to host, execute, and/or otherwise provide one or more transaction processing programs, such as an online banking application, fund transfer applications, and/or other programs associated with the financial institution. The enterprise application host platform 125 may comprise various servers and/or databases that store and/or otherwise maintain account information, such as financial account information including account balances, transaction history, account owner information, and/or other information. In addition, the enterprise application host platform 125 may process and/or otherwise execute transactions on specific accounts based on commands and/or other information received from other computer systems comprising the computing environment 100.

The enterprise user computing device 120 may be a personal computing device (e.g., desktop computer, laptop computer) or mobile computing device (e.g., smartphone, tablet). In addition, the enterprise user computing device 120 may be linked to and/or operated by a specific enterprise user (who may, for example, be an employee or other affiliate of the enterprise organization).

The transaction database 115 may comprise computer-readable storage media storing information associated with various activities and/or transactions performed by clients associated with the enterprise organization. For example, the enterprise organization may correspond to a financial institution and the various transactions and/or activities may correspond to transactions/activities performed at ATMs 150, banking centers (e.g., via banking center computing device(s) 145, via online banking interfaces/portals, via mobile banking applications, via phone banking etc. In an arrangement, the enterprise application host platform 125 may process transaction requests (e.g., as received user device(s) 140, banking center computing device(s) 145, ATMs 150, payment processor server(S) 155, etc., and store a record of the processed transactions in the transaction database 115.

Computer-readable storage media, associated with the transaction database 115, may include volatile and nonvolatile, removable and non-removable media implemented in any method or technology for storage of information such as computer readable instructions, data structures, program modules or other data. Computer-readable storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by the various devices in the private network 130 and the public network 135.

The user device 140 may be a computing device (e.g., desktop computer, laptop computer) or mobile computing device (e.g., smartphone, tablet). The user device 140 may be configured to enable a user (e.g., a client of the financial institution) to access the various functionalities provided by the devices, applications, and/or systems in the private network 130. For example, the user device 140 may be a smartphone configured with an application associated with the financial institution which may be used to perform banking transactions (e.g., checking account balances, initiating fund transfers, depositing checks, paying credit card balances, etc.).

The banking center computing device 145 may be a computing device (e.g., desktop computer, laptop computer) or mobile computing device (e.g., smartphone, tablet). The banking center computing device 145 may be located in a physical banking location (e.g., of the financial institution) and may be configured to enable an authorized user associated with the financial institution (e.g., an employee) to perform banking transactions (e.g., on behalf of a client of the financial institution). The banking transactions may correspond to checking account balances, initiating fund transfers, depositing checks, paying credit card balances, withdrawing cash, etc.

The payment processor server 155 may comprise one or more computing devices and/or other computer components (e.g., processors, memories, communication interfaces). The payment processor server(s) 155 may be associated with a card network and may communicate with enterprise application host platform 125 to process card-based transactions. The card-based transactions may be via point of sale (POS) device(s) or via website-based online interfaces (e.g., associated with online shopping portals, or bill payment interfaces, etc.). The payment processing server(s) 155 may receive a request for a card-based transaction (e.g., when a user uses a credit/debit card at the POS device(s) or an online interface) and forward information associated with the transaction to the enterprise application host platform 125. For example, the payment processor server(s) 155 may receive and subsequently indicate, to the enterprise application host platform 125, a merchant name associated with the transaction, a description associated with the transaction, a transaction value, credit card/debit card information (e.g., card number, card verification value (CVV)), etc.

In one or more arrangements, the monitoring platform 110, the transaction database 115, the enterprise application host platform 125, the enterprise user computing device 120, the user device(s) 140, the banking center computing device(s) 145, the automatic teller machines (ATMs) 150, the payment processor server(s) 155 and/or the other devices/systems in the computing environment 100 may be any type of computing device capable of receiving input via a user interface, and communicating the received input to one or more other computing devices in the computing environment 100. For example, the monitoring platform 110, the transaction database 115, the enterprise application host platform 125, the enterprise user computing device 120, the user device(s) 140, the banking center computing device(s) 145, the payment processor server(s) 155, and/or the other devices/systems in the computing environment 800 may, in some instances, be and/or include server computers, desktop computers, laptop computers, tablet computers, smart phones, wearable devices, or the like that may comprised of one or more processors, memories, communication interfaces, storage devices, and/or other components. In one or more arrangements, the monitoring platform 110, the transaction database 115, the enterprise application host platform 125, the enterprise user computing device 120, the user device(s) 140, the banking center computing device(s) 145, the payment processor server(s) 155, and/or the other devices/systems in the computing environment 100 may be any type of display device, audio system, wearable devices (e.g., a smart watch, fitness tracker, etc.). Any and/or all of the monitoring platform 110, the transaction database 115, the enterprise application host platform 125, the enterprise user computing device 120, the user device(s) 140, the banking center computing device(s) 145, the payment processor server(s) 155, and/or the other devices/systems in the computing environment 100 may, in some instances, be and/or comprise special-purpose computing devices configured to perform specific functions.

FIG. 1B shows an example monitoring platform 110 in accordance with one or more examples described herein. The monitoring platform 110 may comprise one or more of host processor(s) 166, medium access control (MAC) processor(s) 168, physical layer (PHY) processor(s) 170, transmit/receive (TX/RX) module(s) 172, memory 160, and/or the like. One or more data buses may interconnect host processor(s) 166, MAC processor(s) 168, PHY processor(s) 170, and/or Tx/Rx module(s) 172, and/or memory 160. The monitoring platform 110 may be implemented using one or more integrated circuits (ICs), software, or a combination thereof, configured to operate as discussed below. The host processor(s) 166, the MAC processor(s) 168, and the PHY processor(s) 170 may be implemented, at least partially, on a single IC or multiple ICs. Memory 160 may be any memory such as a random-access memory (RAM), a read-only memory (ROM), a flash memory, or any other electronically readable memory, or the like.

Messages transmitted from and received at devices in the computing environment 800 may be encoded in one or more MAC data units and/or PHY data units. The MAC processor(s) 168 and/or the PHY processor(s) 170 of the monitoring platform 110 may be configured to generate data units, and process received data units, that conform to any suitable wired and/or wireless communication protocol. For example, the MAC processor(s) 168 may be configured to implement MAC layer functions, and the PHY processor(s) 170 may be configured to implement PHY layer functions corresponding to the communication protocol. The MAC processor(s) 168 may, for example, generate MAC data units (e.g., MAC protocol data units (MPDUs)), and forward the MAC data units to the PHY processor(s) 170. The PHY processor(s) 170 may, for example, generate PHY data units (e.g., PHY protocol data units (PPDUs)) based on the MAC data units. The generated PHY data units may be transmitted via the TX/RX module(s) 172 over the private network 130. Similarly, the PHY processor(s) 170 may receive PHY data units from the TX/RX module(s) 170, extract MAC data units encapsulated within the PHY data units, and forward the extracted MAC data units to the MAC processor(s). The MAC processor(s) 168 may then process the MAC data units as forwarded by the PHY processor(s) 170.

One or more processors (e.g., the host processor(s) 166, the MAC processor(s) 168, the PHY processor(s) 170, and/or the like) of the monitoring platform 110 may be configured to execute machine readable instructions stored in memory 160. The memory 160 may comprise (i) one or more program modules/engines having instructions that when executed by the one or more processors cause the monitoring platform 110 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the monitoring platform 110 and/or by different computing devices that may form and/or otherwise make up the monitoring platform 110. The memory 160 may have, store, and/or comprise the artificial intelligence (AI)/machine learning (ML) engine(s) 162, a natural language processing (NLP)/natural language understanding (NLU) engine 163, and/or the rules repository 164. For example, the AI/ML engine(s) 162 may determine, based on historical transaction data, one or more rules for identifying potential mule accounts by a rules engine. The rules repository 164 may store the determined rules. In another example, the AI/ML engine(s) 162 may be trained to identify potential mule accounts based on transaction data. The NLP/NLU engine 163 may determine transactions that involve cryptocurrency and refine the transaction data for use by the AI/ML engine(s) 162, as further described herein.

The AI/ML engine(s) 162 may receive data and, using one or more AI/ML algorithms, may generate one or more machine learning datasets (e.g., AI models). Various AI/ML algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative AI/ML algorithms may be used without departing from the invention. As further described herein, the AI/ML algorithms and generated AI models may be used for detecting suspected money mule accounts based on client transactions/activities as received and recorded by the transaction database 115.

While FIG. 1A illustrates the monitoring platform 110, the transaction database 115, the enterprise application host platform 125, and the enterprise user computing device 120 as being separate elements connected in the private network 130, in one or more other arrangements, functions of one or more of the above may be integrated in a single device/network of devices. For example, elements in the monitoring platform 110 (e.g., host processor(s) 166, memory(s) 160, MAC processor(s) 168, PHY processor(s) 170, TX/RX module(s) 172, and/or one or more program/modules stored in memory(s) 160) may share hardware and software elements with and corresponding to, for example, the monitoring platform 110, the transaction database 115, the enterprise application host platform 125, and the enterprise user computing device 120.

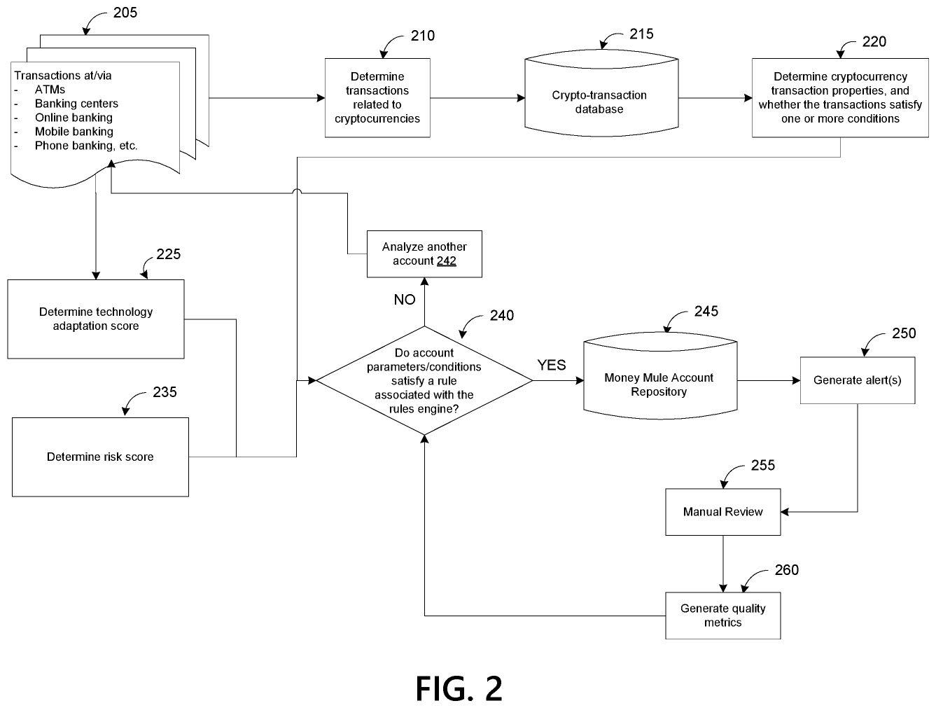

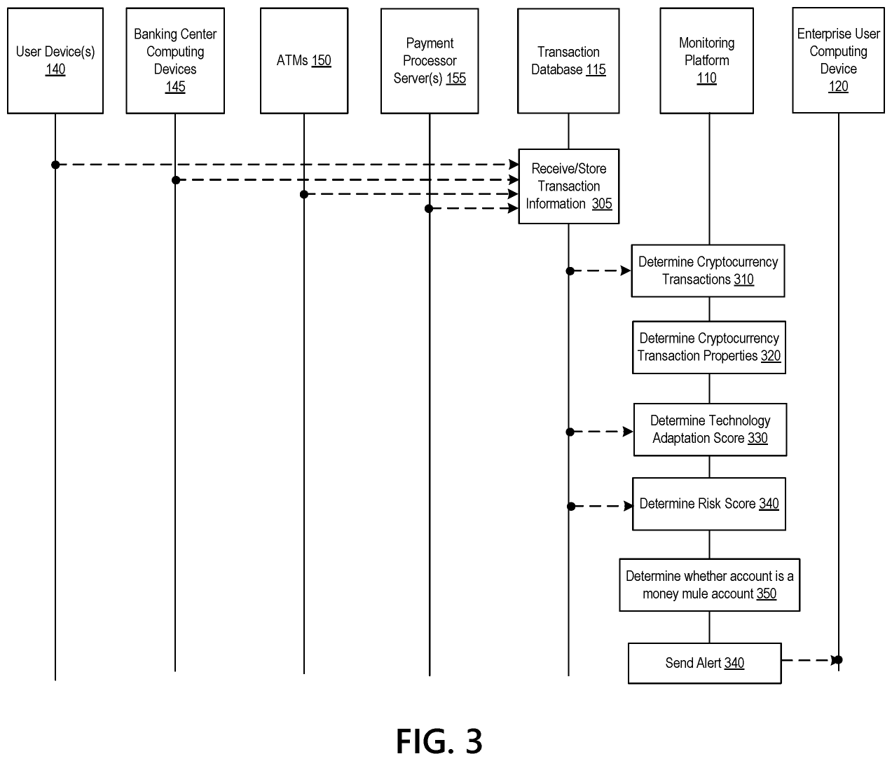

FIG. 2 shows an example method for detection of money mule accounts, in accordance with various examples described herein. The example method may be performed by the monitoring platform 110. FIG. 3 shows an example event sequence for detection of money mule accounts, in accordance with various examples described herein (e.g., corresponding to FIG. 2).

The monitoring platform 110 may continuously monitor transactions 205 being performed by users, associated with the financial institution, via various banking platforms. The transactions 205 may correspond to ATM transactions, banking center transactions, online banking transactions, mobile banking transactions, phone banking transactions, credit card transactions, etc.

The transactions 205 may correspond to user banking accounts associated with the users. Transactions 205 may comprise both financial and non-financial transactions. Financial transactions may correspond to transactions involving account transfers, purchases (e.g., online purchases), depositing of checks, withdrawal of cash, or any other transactions that may involve changes to an account balance. Non-financial transactions may correspond to any other user activity that does not result in a change to an account balance. For example, a non-financial transaction may comprise user activity associated with checking of an account balance, a login to an online banking interface, a phone call to use a phone-based customer service system for general banking or account related enquiries, etc.

For example, ATM transactions may correspond to using an ATM card to check an account balance, withdraw/deposit cash into the account, etc., at ATMs 150. A banking center transaction may correspond to using a banking center physical location to deposit/withdraw cash, deposit checks, request certified checks, etc. Banking center transaction information may be received from banking center computing device(s) 145. An online banking transaction/mobile banking transaction may correspond to using an online banking interface (e.g., a website) or a mobile banking application to check account balances, initiate an electronic fund transfer, pay credit card bills, make payments for online purchases, etc. Online banking transactions/mobile banking transaction information may be received from the enterprise application host platform 125. A phone banking transaction may correspond to using a phone-based customer service system to perform various banking operations similar to as described above. The transactions may correspond to credit card transactions comprising online/offline credit card purchases. Credit card transactions may be processed by the payment processor server(s) 155. In an arrangement, the transactions 205 may be stored in the transaction database 115. Information associated with the transactions 205 may be received from various platforms/devices (e.g., ATMs 150, banking center computing device(s) 145, user device(s) 140, payment processor server(s) 155, enterprise user computing device(s) 120, enterprise application host platform 125, etc.) within the computing environment 100 and stored in the transaction database 115 (e.g., step 305).

Each transaction may be associated with a corresponding transaction value and a description. For example, an online banking transaction may correspond to an electronic fund transfer. The online banking transaction may be associated with a transaction value, source account information, destination account information, a vendor name for an online banking purchase, and/or transaction time. Similarly, a credit/debit card purchase transaction may be associated with a name of a vendor where the credit/debit card was used, a transaction value, etc. Non-financial transactions need not be associated with a transaction value, and may only have an associated description. For example, a transaction corresponding to a telephone call for account related enquiries may comprise an indication of a specific query by a user (e.g., indicating an account balance check). Information associated with the transactions 205 as received from various platforms/devices (e.g., ATMs 150, banking center computing device(s) 145, user device(s) 140, payment processor server(s) 155, enterprise user computing device(s) 120, enterprise application host platform 125, etc.) within the computing environment 100 may comprise transaction values and descriptions associated with each transaction.

At step 210 (step 310 of FIG. 3), the transaction monitoring platform 110 (e.g., a crypto-transaction parser associated with the transaction monitoring platform 110) may determine transactions, among the plurality of transactions 205, that relate to cryptocurrency. A cryptocurrency transaction may correspond/relate to purchase and/or sale of cryptocurrency via a cryptocurrency exchange. In an example, the crypto-transaction parser may use an NLP/NLU engine 163 to identify cryptocurrency transactions. The NLP/NLU engine 163 may be trained to identify patterns associated with cryptocurrency transactions using a ML model. The NLP/NLU engine 163 may search for keywords within the transaction description to identify cryptocurrency transactions. The keywords may comprise names associated with known cryptocurrency exchanges (e.g., Binance, Coinbase, Kraken, etc.), names associated with cryptocurrencies (etherium (ETH), bitcoin (BTC), Helium (HNT), etc.). For example, an online banking transaction may comprise an account transfer to a cryptocurrency wallet associated with a cryptocurrency exchange. A credit card transaction may be for cryptocurrency purchase at a cryptocurrency exchange. The NLP/NLU engine 163 may determine that the transaction description comprises text indicating a name of the cryptocurrency exchange. The crypto-transaction parser 210 may, based on the determination made by the NLP/NLU engine 163, add a tag to transactions identified as cryptocurrency transactions. Transactions identified/tagged as cryptocurrency transactions may be stored in a crypto-transaction database 215.

At step 220 (step 320 of FIG. 3), the monitoring platform 110 may determine properties associated with cryptocurrency transactions corresponding to each user account based on information stored in the crypto-transaction database. The cryptocurrency transaction properties may comprise one or more of a frequency of the cryptocurrency transactions via the user account, a total quantity of cryptocurrency transactions, a quantity of transactions per time period (e.g., per day, per week, per month, etc.) via the user account, transaction values of the cryptocurrency transactions (e.g., outgoing/incoming value of transfers to/from a cryptocurrency wallet), a median value of the cryptocurrency transactions (e.g., all cryptocurrency transactions and/or cryptocurrency transactions with time period), etc.

Additionally, or alternatively, the monitoring platform 110 may be trained to identify whether the cryptocurrency transactions satisfy one or more other conditions. For the conditions may be one or more of: whether the user account is being used to frequently buy cryptocurrency (e.g., a quantity/frequency of cryptocurrency purchases exceeding a threshold quantity), whether the user account is being used to frequently switch between different cryptocurrency types, whether the user account is being used to purchase high value cryptocurrency (e.g., cryptocurrency purchases exceeding a threshold percentage of total account value), whether the user account is associated with different channels of cryptocurrency purchase (e.g., user account linked to multiple cryptocurrency wallets), whether the user account is being used to purchase cryptocurrency when located in particular geographic location (e.g., an IP address of a user device used to purchase cryptocurrency corresponds to a country categorized as being associated with money mule activity), etc. In an arrangement, the monitoring platform 110 may use a trained machine learning model to determine whether the cryptocurrency transactions satisfy the one or more conditions. The monitoring platform 110 may determine, for each account, corresponding cryptocurrency transaction properties and/or whether the one or more conditions are satisfied for a user account for each time period (e.g., every week, every month, or any other time interval).

At step 225 (step 330 in FIG. 3), the monitoring platform 110 may generate a technology adaptation score for each user account based on the transactions 205 (e.g., as stored in the transaction database 115). For example, a regression algorithm (e.g., a decision tree algorithm, random forest algorithm, k-nearest neighbor algorithm, support vector machines (SVMs), etc.) may be used to determine the technology adaptation score. The technology adaptation score may be a measure of usage of technology (e.g., remote banking via a user device 140, using an online banking portal and/or a mobile banking application to perform banking operations, etc.) by a user. A higher frequency of usage of a mobile banking application and/or an online banking portal (e.g., a higher frequency/quantity of logins to an online banking portal, a higher frequency of online banking transactions for electronic fund transfers and/or depositing of checks, a higher frequency of credit card payments made via the online banking portal, etc.) may result in a higher technology adaptation score for a user. A lower frequency of usage of a mobile banking application or a banking portal (and/or a more frequent usage of ATMs, banking center computing devices 145, phone based customer service systems, etc., may result in a lower technology adaptation score for a user. The monitoring platform 110 may determine technology adaptation scores for a user account for each time period (e.g., every week, every month, or any other time interval) and maintain a historical record of technology adaptation scores for the user account.

In addition to the technology adaptation score, the monitoring platform 110 may generate a risk score for each account (step 235 of FIG. 2, step 340 of FIG. 3). Risk scores may be generate based on transactions 205 as stored in the transaction database 115. Risk scores may be based on general user activity corresponding to an account and user identity based on know your customer (KYC) guidelines. For example, a higher rate/value of cash deposits into an account may result in a higher risk score for the account. As another example, locations of online and offline banking transactions may be used to generate risk scores. If a country used for offline banking transactions (e.g., at a banking center physical location) does not match an IP address used for online banking transactions for an account, the monitoring platform 110 may assign risk score to the account. If an IP address used for online banking transactions for an account corresponds to a country/geographic location that is categorized as “high risk,” the monitoring platform 110 may assign risk score to the account. Other standardized techniques may be used for determining risk scores based on transaction activity associated with the account. The monitoring platform 110 may determine risk scores for a user account for each time period (e.g., every week, every month, or any other time interval) and maintain a historical record of risk scores for the user account.

At step 240 (step 350 of FIG. 3), the monitoring platform 110 may use a rules engine to determine whether an account is suspected/determined to be a money mule account. The rules engine may use a stored listing of rules to determine whether an account is suspected/determined to be a money mule account. The rules engine may use, to determined whether an account is suspected/determined to be a money mule account, one or more of: determined cryptocurrency transaction properties associated with the account, a determination of whether transactions associated with the account satisfy one or more conditions (e.g., as determined at step 220), a technology adaptation score associated with the account, and/or a risk score associated with the account. If information associated with one or more of the above satisfy a rule in the stored listing of rules, the monitoring platform may determine that the account may be a money mule account.

Each of the rules in the stored listing of rules may comprise a combination of: cryptocurrency transaction properties, a technology adaptation score, a risk score, and/or one or more other conditions etc., based on which an account may be determined to be a money mule account. For example, the rules engine may determine that an account is a money mule account if determined parameters/conditions (e.g., cryptocurrency transaction properties associated with the account, a technology adaptation score associated with the account, a risk score, and/or one or more conditions (e.g., as determined at step 220) being true, etc.) associated with the account satisfies a rule in the stored listing of rules. The monitoring platform 110 may (step 242) analyze another account (e.g., based on steps 205-240) if the determined parameters/conditions associated with the account does not satisfy a rule in the stored listing of rules.

As an example, the rules engine may determine that the account may be money mule account if one or more of a frequency of the cryptocurrency transactions in a time period, a total quantity of cryptocurrency transactions in the time period, a transaction value of a cryptocurrency transaction in the time period, and/or a median value of the cryptocurrency transactions in the time period exceed corresponding threshold values. The rules engine may determine that the account may be money mule account if (e.g., in addition to satisfaction of the one or more above criteria) a technology adaptation score for the time period is anomalous. The rules engine may determine that the account may be money mule account if (e.g., in addition to satisfaction of the one or more above criteria) if a risk score for the time period is anomalous. A technology adaptation score for a time period may be determined to be anomalous if it exceeds an historical average technology adaptation score for the account by a threshold value. A risk score for a time period may be determined to be anomalous if it exceeds an historical average risk score for the account by a threshold value.

The rules engine may determine that an account may be a money mule account if one or more of the conditions (e.g., as determined at step 220) are satisfied and/or one or both of a risk score and/or a technology adaptation score are anomalous. For example, the rules engine may determine that an account may be a money mule account if the rules engine determines that transactions associated with the account include purchase of high value cryptocurrency within a time period, in addition to a risk score and/or a technology adaptation score for the time period being anomalous. The rules engine may determine that an account may be a money mule account if the rules engine determines that transactions associated with the account in a time period include a quantity of cryptocurrency transactions that exceed a threshold value, in addition to a risk score and/or a technology adaptation score for the time period being anomalous.

AI-based techniques may be used for determining whether a risk score or a technology adaptation score is anomalous. For example, the monitoring platform 110 may use a clustering algorithm to determine/group normal risk scores or technology adaptation scores associated with an account. The clustering algorithm may comprise one or more of hierarchical clustering, centroid based clustering, density based clustering, and/or distribution based clustering. Any future scores that fall outside of this group may be determined as anomalous. For example, a future technology adaptation score may be determined to be outside a group if the distance(s) between the measurement and core point(s) associated with the group is/are greater than a threshold value.

The rules used by the rules engine may be stored in the rules repository 164 associated with the monitoring platform. The rules may be determined by the AI/ML engine(s) 162 based on training transaction data. For example, historical transactions within the computing environment 100 may be used as training data to build the rules repository. The historical transactions may be processed in a manner as described above with respect to steps 210-235 to determine, corresponding to each account, cryptocurrency transaction properties (e.g., frequency of cryptocurrency transactions, a total quantity of cryptocurrency transactions, a quantity of transactions per time period via the user account, transaction values of the cryptocurrency transactions, a median value of the cryptocurrency transactions, etc.), whether one or more conditions are satisfied (e.g., account being used to frequently buy cryptocurrency, frequently switch between different cryptocurrency types, purchase high value cryptocurrency, using different channels of cryptocurrency purchase, purchase cryptocurrency when located in particular geographic location, etc.), a technology adaptation score, and/or risk score. Based on the manual review (e.g., at the enterprise user computing device 120) of the determined cryptocurrency transaction properties, indications of whether the cryptocurrency transaction(s) satisfy one or more of the conditions, the technology adaptation score, and/or the risk score, an administrative user may tag an account as a suspected money mule account. The AI/ML engine(s) 162 may generate rules for identification of money mule accounts based on the administrative user input. The rules may include one or more criteria associated with cryptocurrency transaction properties, whether cryptocurrency transaction(s) satisfy one or more of the conditions, a technology adaptation score, and/or a risk score as described herein.

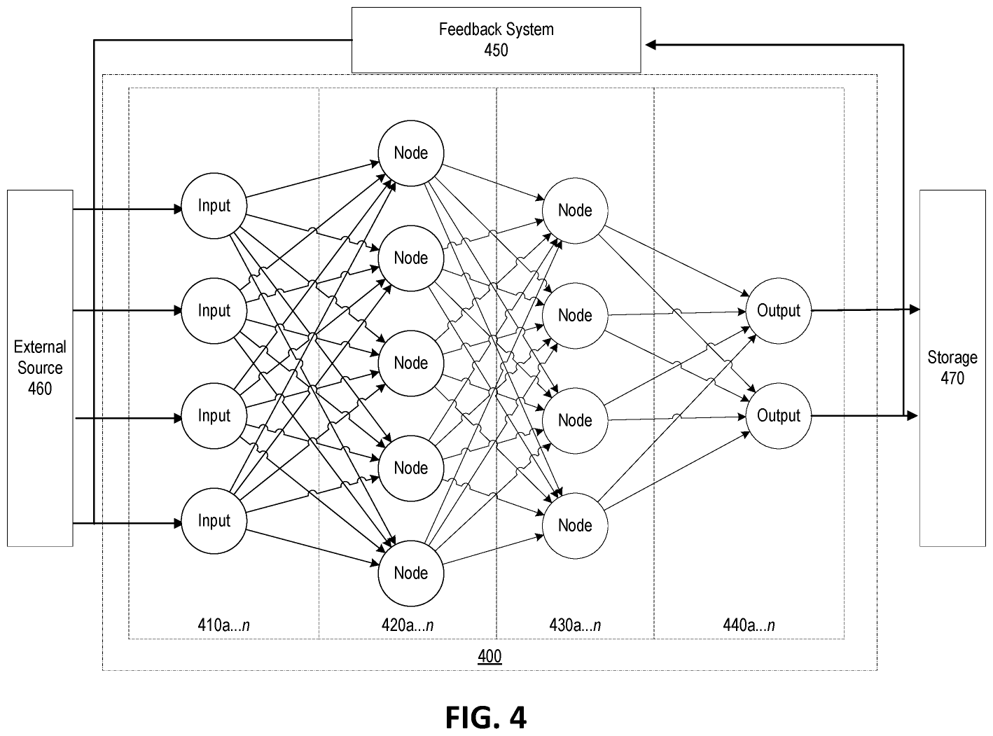

Other machine learning algorithms may be used by the AI/ML engine(s) 162 to identify potential money mule accounts. The AI/ML engine(s) 162 may generate an AI model based on historical transaction data and the manual review (e.g., at the enterprise user computing device 120) of the historical transaction data. For example, a neural network may be trained using historical transaction data to identify potential money mule accounts. An input to the neural network may be cryptocurrency transaction properties (e.g., frequency of cryptocurrency transactions, a total quantity of cryptocurrency transactions, a quantity of transactions per time period via the user account, transaction values of the cryptocurrency transactions, a median value of the cryptocurrency transactions, etc.) of an account, whether one or more conditions are satisfied (e.g., account being used to frequently buy cryptocurrency, frequently switch between different cryptocurrency types, purchase high value cryptocurrency, using different channels of cryptocurrency purchase, purchase cryptocurrency when located in particular geographic location, etc.) for the account, a technology adaptation score for the account, and/or risk score for the account. The output from the neural network may be an indication of whether or not the account is a money mule account. Further details associated with using a neural network are described with respect to FIG. 4.

The identified money mule accounts may be stored in a money mule account repository 245 for further review. At step 250 (step 360 of FIG. 3), one or more alerts may be generated and sent to one or more devices (e.g., the enterprise user computing device 120), within the computing environment 100, indicating the identified money mule accounts. At step 225, an administrative user (e.g., at the enterprise user computing device 120) may manually review the identified money mule accounts to manually review whether the monitoring platform 110 was correct in its initial determination of the money mule accounts. At step 260, the monitoring platform 110 may generate quality metrics based on money mule accounts identified by the monitoring platform and manual review of the identified money mule accounts. Quality metrics may comprise a percentage of false positives as detected by the rules engine at step 240. For example, an account may be determined to be a money mule account by the monitoring platform but on further manual review may be flagged as a non-money mule account. The quality metrics may be used to refine the rules used by the rules engine for determination of the money mule account. For example, the administrative user may manually modify the rules used by the rules engine to reduce the possibility of detection of false positives.

FIG. 4 illustrates a simplified example of an artificial neural network 400 on which a machine learning algorithm may be executed. The machine learning algorithm may be used at the AI/ML engine(s) 162 to perform one or more functions of the monitoring platform 110, as described herein. FIG. 4 is merely an example of nonlinear processing using an artificial neural network; other forms of nonlinear processing may be used to implement a machine learning algorithm in accordance with features described herein.

In one example, a framework for a machine learning algorithm may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks. Such structures, while significantly more complex than conventional computer systems, are beneficial in implementing machine learning. For example, an artificial neural network may be comprised of a large set of nodes which, like neurons, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator.

Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 1000 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “95% correct”).

One theory underlying supervised learning is inductive learning. In inductive learning, a data representation is provided as input samples data (x) and output samples of the function (f(x)). The goal of inductive learning is to learn a good approximation for the function for new data (x), i.e., to estimate the output for new input samples in the future. Inductive learning may be used on functions of various types: (1) classification functions where the function being learned is discrete; (2) regression functions where the function being learned is continuous; and (3) probability estimations where the output of the function is a probability.

In practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals more clear, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

By way of example, in FIG. 4, each of input nodes 410a-n is connected to a first set of processing nodes 420a-n. Each of the first set of processing nodes 420a-n is connected to each of a second set of processing nodes 430a-n. Each of the second set of processing nodes 430a-n is connected to each of output nodes 440a-n. Though only two sets of processing nodes are shown, any number of processing nodes may be implemented. Similarly, though only four input nodes, five processing nodes, and two output nodes per set are shown in FIG. 4, any number of nodes may be implemented per set. Data flows in FIG. 4 are depicted from left to right: data may be input into an input node, may flow through one or more processing nodes, and may be output by an output node. Input into the input nodes 410a-n may originate from an external source 460. The input from the input nodes may be, for example, cryptocurrency transaction properties (e.g., frequency of cryptocurrency transactions, a total quantity of cryptocurrency transactions, a quantity of transactions per time period via the user account, transaction values of the cryptocurrency transactions, a median value of the cryptocurrency transactions, etc.) of an account, whether one or more conditions are satisfied (e.g., account being used to frequently buy cryptocurrency, frequently switch between different cryptocurrency types, purchase high value cryptocurrency, using different channels of cryptocurrency purchase, purchase cryptocurrency when located in particular geographic location, etc.) for the account, a technology adaptation score for the account, and/or risk score for the account. Output may be sent to a feedback system 450 and/or to storage 470. The output from an output node may be an indication of whether the account is a money mule account. The output from an output node may be a notification to a computing device to manually review transactions associated with the account. The feedback system 450 may send output to the input nodes 410a-n for successive processing iterations with the same or different input data.

In one illustrative method using feedback system 450, the system may use machine learning to determine an output. The system may use one of a myriad of machine learning models including xg-boosted decision trees, auto-encoders, perceptron, decision trees, support vector machines, regression, and/or a neural network. The neural network may be any of a myriad of type of neural networks including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tanh function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting—regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially.

In one example, FIG. 4 depicts nodes that may perform various types of processing, such as discrete computations, computer programs, and/or mathematical functions implemented by a computing device. For example, the input nodes 410a-n may comprise logical inputs of different data sources, such as one or more data servers. The processing nodes 420a-n may comprise parallel processes executing on multiple servers in a data center. And, the output nodes 440a-n may be the logical outputs that ultimately are stored in results data stores, such as the same or different data servers as for the input nodes 410a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 400 may learn and/or be dynamically reconfigured. Though nodes are depicted as having connections only to successive nodes in FIG. 4, connections may be formed between any nodes. For example, one processing node may be configured to send output to a previous processing node.

Input received in the input nodes 410a-n may be processed through processing nodes, such as the first set of processing nodes 420a-n and the second set of processing nodes 430a-n. The processing may result in output in output nodes 440a-n. As depicted by the connections from the first set of processing nodes 420a-n and the second set of processing nodes 430a-n, processing may comprise multiple steps or sequences. For example, the first set of processing nodes 420a-n may be a rough data filter, whereas the second set of processing nodes 430a-n may be a more detailed data filter.

The artificial neural network 400 may be configured to effectuate decision-making. As a simplified example for the purposes of explanation, the artificial neural network 400 may be configured to detect faces in photographs. The input nodes 410a-n may be provided with a digital copy of a photograph. The first set of processing nodes 420a-n may be each configured to perform specific steps to remove non-facial content, such as large contiguous sections of the color red. The second set of processing nodes 430a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 400 may then predict the location on the face. The prediction may be correct or incorrect.

The feedback system 450 may be configured to determine whether or not the artificial neural network 400 made a correct decision. Feedback may comprise an indication of a correct answer and/or an indication of an incorrect answer and/or a degree of correctness (e.g., a percentage). For example, in the facial recognition example provided above, the feedback system 450 may be configured to determine if the face was correctly identified and, if so, what percentage of the face was correctly identified. The feedback system 450 may already know a correct answer, such that the feedback system may train the artificial neural network 400 by indicating whether it made a correct decision. The feedback system 450 may comprise human input, such as an administrator telling the artificial neural network 400 whether it made a correct decision. The feedback system may provide feedback (e.g., an indication of whether the previous output was correct or incorrect) to the artificial neural network 400 via input nodes 410a-n or may transmit such information to one or more nodes. The feedback system 450 may additionally or alternatively be coupled to the storage 470 such that output is stored. The feedback system may not have correct answers at all, but instead base feedback on further processing: for example, the feedback system may comprise a system programmed to identify faces, such that the feedback allows the artificial neural network 400 to compare its results to that of a manually programmed system.

The artificial neural network 400 may be dynamically modified to learn and provide better input. Based on, for example, previous input and output and feedback from the feedback system 450, the artificial neural network 400 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally or alternatively, the node may be reconfigured to process photos differently. The modifications may be predictions and/or guesses by the artificial neural network 400, such that the artificial neural network 400 may vary its nodes and connections to test hypotheses.

The artificial neural network 400 need not have a set number of processing nodes or number of sets of processing nodes, but may increase or decrease its complexity. For example, the artificial neural network 400 may determine that one or more processing nodes are unnecessary or should be repurposed, and either discard or reconfigure the processing nodes on that basis. As another example, the artificial neural network 400 may determine that further processing of all or part of the input is required and add additional processing nodes and/or sets of processing nodes on that basis.

The feedback provided by the feedback system 450 may be mere reinforcement (e.g., providing an indication that output is correct or incorrect, awarding the machine learning algorithm a number of points, or the like) or may be specific (e.g., providing the correct output). For example, the machine learning algorithm 400 may be asked to detect faces in photographs. Based on an output, the feedback system 450 may indicate a score (e.g., 75% accuracy, an indication that the guess was accurate, or the like) or a specific response (e.g., specifically identifying where the face was located).

The artificial neural network 400 may be supported or replaced by other forms of machine learning. For example, one or more of the nodes of artificial neural network 400 may implement a decision tree, associational rule set, logic programming, regression model, cluster analysis mechanisms, Bayesian network, propositional formulae, generative models, and/or other algorithms or forms of decision-making. The artificial neural network 400 may effectuate deep learning.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein describe threat detection using a validation server and based on hash analysis. Using the validation server may ensure reduced resource utilization at a user device and use of updated hash databases. Further, hash analysis may ensure that an entire element of a DOM need not necessarily be sent for analysis. The validation server (and/or other servers) may be configured to implement countermeasures based on risks associated with a particular user/webpage, enabling prioritization of more urgent/significant threats.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A monitoring platform, comprising:
at least one processor; and
memory storing computer-readable instructions that, when executed by the at least one processor, cause the monitoring platform to:
receive, for a plurality of time periods, wherein the time periods are daily, weekly, and monthly, activity information associated with a user banking account corresponding to a user, wherein the activity information comprises a record of transactions associated with one or more banking platforms, wherein the record of transactions comprises financial transactions involving a change to an account balance, and non-financial transactions not associated with a transaction value;
determine, based on the activity information, one or more transactions, among the transactions, associated with cryptocurrency and further determine properties associated with the one or more transactions, wherein each transaction in the record of transactions is associated with a description, and wherein the determining the one or more transactions is based on performing natural language processing (NLP) on descriptions associated with the transactions;
calculate, based on the activity information, technology adaptation scores associated with the plurality of time periods, wherein the technology adaptation score is based at least on a frequency of usage of an online banking portal;
determine, using a rules engine, based on the properties and the technology adaptation scores, whether the user banking account is a money mule account; and
based on a determination that the user banking account is a money mule account, perform a remedial action.

2. The monitoring platform of claim 1, wherein the rules engine comprises a plurality of rules, wherein the plurality of rules is determined at least based on historical activity information associated with a plurality of user banking accounts.

3. (canceled)

4. The monitoring platform of claim 1, wherein the properties comprise one of:
transaction values corresponding to the one or more transactions;
transaction frequencies of transactions corresponding to one or more transaction types;
a median transaction value corresponding to the one or more transactions;
a mean transaction value corresponding to the one or more transactions; and
combinations thereof.

5. The monitoring platform of claim 4, wherein the one or more transaction types comprises one of:
a first transaction type indicating an outgoing fund transfer to a cryptocurrency account;
a second transaction type indicating an incoming fund transfer from a cryptocurrency account; and
combination thereof.

6. The monitoring platform of claim 1, wherein the banking platforms comprise one of:
automatic teller machines (ATMs);
computing devices at physical banking locations;
the online banking portal accessible via a uniform resource locator (URL);
call center platforms for phone banking; and
combinations thereof.

7. The monitoring platform of claim 1, wherein the transactions comprise one of:
checking an account balance of the user banking account;
initiating an outgoing fund transfer from the user banking account;
logging into the user banking account via the online banking portal;
receiving an incoming fund transfer to the user banking account;
using automatic teller machines (ATMs) to access the user banking account; and
combinations thereof.

8. The monitoring platform of claim 7, wherein:
the outgoing fund transfer is a fund transfer to a cryptocurrency wallet; and
the incoming fund transfer is a fund transfer from the cryptocurrency wallet.

9. The monitoring platform of claim 1, wherein the performing the remedial action comprises sending, to a computing device, a notification indicating the user banking account.

10. A method comprising:
receiving, for a plurality of time periods, wherein the time periods are daily, weekly, and monthly, activity information associated with a user banking account corresponding to a user, wherein the activity information comprises a record of transactions associated with one or more banking platforms, wherein the record of transactions comprises financial transactions involving a change to an account balance, and non-financial transactions not associated with a transaction value;
determining, based on the activity information, one or more transactions, among the transactions, associated with cryptocurrency and further determine properties associated with the one or more transactions, wherein each transaction in the record of transactions is associated with a description, and wherein the determining the one or more transactions is based on performing natural language processing (NLP) on descriptions associated with the transactions;
calculating, based on the activity information, technology adaptation scores associated with the plurality of time periods, wherein the technology adaptation score is based at least on a frequency of usage of an online banking portal;
determining, using a rules engine, based on the properties and the technology adaptation scores, whether the user banking account is a money mule account; and
based on a determination that the user banking account is a money mule account, performing a remedial action.

11. The method of claim 10, wherein the rules engine comprises a plurality of rules, wherein the plurality of rules is determined at least based on historical activity information associated with a plurality of user banking accounts.

12. (canceled)

13. The method of claim 10, wherein the properties comprise one of:
transaction values corresponding to the one or more transactions;
transaction frequencies of transactions corresponding to one or more transaction types;
a median transaction value corresponding to the one or more transactions;
a mean transaction value corresponding to the one or more transactions; and
combinations thereof.

14. The method of claim 10, wherein the one or more transaction types comprises one of:
a first transaction type indicating an outgoing fund transfer to a cryptocurrency account;
a second transaction type indicating an incoming fund transfer from a cryptocurrency account; and
combination thereof.

15. The method of claim 10, wherein the transactions comprise one of:
checking an account balance of the user banking account;
initiating an outgoing fund transfer from the user banking account;
logging into the user banking account via the online banking portal;
receiving an incoming fund transfer to the user banking account;
using automatic teller machines (ATMs) to access the user banking account; and
combinations thereof.

16. The method of claim 10, wherein the performing the remedial action comprises sending, to a computing device, a notification indicating the user banking account.

17. A non-transitory computer readable medium storing instructions that, when executed, cause:
receiving, for a plurality of time periods, wherein the time periods are daily, weekly, and monthly, activity information associated with a user banking account corresponding to a user, wherein the activity information comprises a record of transactions associated with one or more banking platforms, wherein the record of transactions comprises financial transactions involving a change to an account balance, and non-financial transactions not associated with a transaction value;
determining, based on the activity information, one or more transactions, among the transactions, associated with cryptocurrency and further determine properties associated with the one or more transactions, wherein each transaction in the record of transactions is associated with a description, and wherein the determining the one or more transactions is based on performing natural language processing (NLP) on descriptions associated with the transactions;
calculating, based on the activity information, technology adaptation scores associated with the plurality of time periods, wherein the technology adaptation score is based at least on a frequency of usage of an online banking portal;
determining, using a rules engine, based on the properties and the technology adaptation scores, whether the user banking account is a money mule account; and
based on a determination that the user banking account is a money mule account, performing a remedial action.

18. The non-transitory computer readable medium of claim 17, wherein the rules engine comprises a plurality of rules, wherein the plurality of rules is determined at least based on historical activity information associated with a plurality of user banking accounts.

19. (canceled)

20. The non-transitory computer readable medium of claim 17, wherein the properties comprise one of:
transaction values corresponding to the one or more transactions;
transaction frequencies of transactions corresponding to one or more transaction types;
a median transaction value corresponding to the one or more transactions;
a mean transaction value corresponding to the one or more transactions; and combinations thereof.
